(19) United States
(12) Patent Application Publication
(10) Pub. No.: US 2018/0176655 A1
(43) Pub. Date: Jun. 21, 2018

(54) WEB-BASED SPORTS REPLAY SYSTEM EQUIPPED WITH A SEARCHABLE MEDIA DATABASE OF SPORTING EVENTS

(71) Applicant: Fan Unleashed, Inc., College Station, TX (US)

(72) Inventors: Adam Isaiah Whitlock, Austin, TX (US); Alexander Steven Whitlock, College Station, TX (US); Chase Gaston Widener, Leander, TX (US)

(21) Appl. No.: 15/577,304

(22) PCT Filed: May 27, 2016
(86) PCT No.: PCT/US16/34499

§ 371 Date: Nov. 27, 2017

Related U.S. Application Data
(60) Provisional application No. 62/166,389, filed on May 26, 2015.

(51) Int. Cl. H04N 21/482; H04N 21/858; H04N 21/475; H04N 21/431; H04N 21/4782; H04N 21/472; H04N 21/2668; H04N 21/466; G06F 17/30

(52) U.S. Cl. CPC H04N 21/4828; H04N 21/8586; H04N 21/4753; H04N 21/4755; G06F 17/3084; H04N 21/4782; H04N 21/47202; H04N 21/2668; H04N 21/4668; H04N 21/4312

(57) ABSTRACT

A web-based system for replaying selected sporting events is provided. The system includes a graphical user interface (GUI) which receives queries regarding sports related videos from a user and which outputs query results in response thereto; a login module which, in response to user input, uniquely identifies a user; a user interest module which identifies sporting interests of the user based on user input; a graphics content module which displays graphics content on the GUI based on the sporting interests of the user; a media database containing video content from a plurality of sporting events in a plurality of sports; a search module which receives search parameters from a user, performs a search on the media database on the basis of input search parameters, and outputs search results in the form of a listing of media which meets the search parameters; and a sports module which displays a plurality of hyperlinks, each relating to a particular sport, wherein selection of one of said plurality of icons launches a sports page related to the sport associated with the selected icon, wherein said sports page contains a plurality of content categories for media in the media database related to the sport associated with the selected icon, and wherein said sports page further contains a search hyperlink which launches said search module.

### CROSS-REFERENCE TO RELATED APPLICATION

This application claims the benefit of priority from PCT/US16/34499, filed May 27, 2016, having the same title and inventors, and which is incorporated herein by reference in its entirety, which claims the benefit of priority from U.S. provisional application No. 62/166,389, filed May 26, 2015, having the same title and the same inventors, and which is incorporated herein by reference in its entirety.

### TECHNICAL FIELD OF THE INVENTION

The present disclosure pertains generally to web-based media player systems, and more particularly to a web-based media replay system for sporting events which has a searchable media database associated therewith.

### BACKGROUND OF THE INVENTION

Various systems and methodologies are known to the art which relate to digital media. Some of these are summarized below.

U.S. 2009/0106200 (Salinas et al.) discloses computer implemented methods and systems for mobilization of video, music, photos and other media, including processes for mobile search, mobile messaging, building a mobile content library, and combinations thereof. Content mobilization may be initiated by entry of search parameters or keywords and followed by retrieval of search results (e.g. videos, images, audio files) from online source(s). Upon selection of a content item by user, the process dynamically retrieves the media from online source. Further, the media file may be dynamically edited and then dynamically transcoded and sent to a mobile device.

U.S. 2011/0030031 (Lussiere et al.) discloses methods and systems for receiving, processing and organizing videos. Organizational tools are provided that allow users the capacity to solicit, mine, clip, aggregate, organize, and search submitted footage. These tools include: a set of electronic folders, a media clipper and a media submit portal. Studios, projects, folders and subfolders exist in a hierarchical relationship in order to arrange media. The hierarchy of folders created by producers may be made accessible by the public for the purpose of submitting media to a particular project. Various content creators may upload video to the system, may create electronic video clips from the uploaded video by selecting subportions of that video, and may submit the electronic video clips to a specific folder which is associated with a project. Producers may view various folders to select submitted video clips for use in a project.

U.S. 2011/0251972 (Martin) discloses systems, methods and software for capturing and/or importing and processing media items such as digital images or video associated with a sporting event such as a marathon or bicycle race. The media items are processed, including bib number or facial recognition if necessary, to associate them with an individual participant. Other input sources may include spectator uploads, external web sites and media sharing or soda!™ networking services. The system aggregates, organizes and generates content, and distributes it via various output channels, which may include event web sites, personal feeds, and other output channels. Preferably, selected content is associated with at least one individual participant in the event, and that content is automatically distributed to channels that are associated with that individual participant.

U.S. 2012/0330889 (William) discloses a system which includes a remote content crawler that continually crawls a digital communication network looking for content to provide to a content aggregator. The content provided to the aggregator may be stored in a form of an entire content file. The content may include an entire movie, television program or electronic book. Alternatively, the content provided to the aggregator may be a reference to a content file that is stored at, or that will be available at one of the remote locations. The content may be a reference to a future, scheduled live sports event that will be made available to system users. The sports event may be provided for a one-time fee, as part of a sports package, for which a fee is collected, or as a free event.

U.S. 2003/0030752 (Begeja et al.) discloses a personalized, customizable multimedia delivery service which works by recording all of the video streams of an appropriate source and interest to a target audience. For example, the service may record content from a collection of (or a particular one of) sports or news channels on television. Once the content is captured and recorded, it is segmented, analyzed and/or classified, and thereafter stored on a platform. For example, the content can be broken down into its component parts, such as video, audio and/or text. The text can include a transcription of the audio portion created before or after the transmission. The text can then purportedly be used as a basis for searching the multimedia content. Once the pertinent segments of the broadcast have been appropriately extracted, for a given user, they can be stitched together for continuous delivery to that user. Users can view the delivered multimedia asset in its entirety, skip between the assets, or view only portions of the assets, as they desire.

In addition to the foregoing, several web browsers are currently known to the art which allow a user to find subject matter of interest on the Internet through the entry of a suitable query. For example, the current version of Google's CHROME web browser provides a search bar in which such queries may be entered. Such queries may be constrained to return only certain types of digital media, such as videos or images, through the selection of appropriate menu options by the user.

### SUMMARY OF THE INVENTION

In one aspect, a web-based system for replaying selected sporting events is provided. The system comprises a graphical user interface (GUI) which receives queries regarding sports related media from a user, and which outputs query results in response thereto; a login module which, in response to user input, uniquely identifies a user; a user interest module which identifies sporting interests of the user based on user input; a graphics content module which displays graphics content on the GUI based on the sporting interests of the user; a media database containing media content from a plurality of sporting events in a plurality of sports; a search module which receives search parameters from a user, performs a search on the media database on the basis of the received search parameters, and outputs search results in the form of a listing of media which satisfies the received search parameters; and a sports module which displays a plurality of hyperlinks, each relating to a particular sport, wherein selection of one of said plurality of hyperlinks launches a sports page related to the sport associated with the selected hyperlink, wherein said sports page contains a plurality of content categories for media in the media database related to the sport associated with the selected hyperlink, and wherein said sports page further contains a search hyperlink which launches said search module.

In another aspect, a method for serving sports related media on demand is provided. In accordance with the method, a media database is provided which contains video content from a plurality of sporting events in a plurality of sports. A web-based application is also provided which includes:
(a) a graphical user interface (GUI),
(b) a login module which, in response to user input, uniquely identifies a user,
(c) a user interest module which identifies sporting interests of the user based on user input,
(d) a graphics content module which displays graphics content on the GUI based on the sporting interests of the user,
(e) a search module which receives search parameters, performs a search on the media database on the basis of the received search parameters, and outputs search results in the form of a listing of media which satisfies the search parameters, and
(f) a sports module which displays on the GUI a plurality of hyperlinks, each relating to a particular sport, wherein selection of one of said plurality of icons launches a sports page related to the sport associated with the selected hyperlink, wherein said sports page contains a plurality of content categories for media in the media database related to the sport associated with the selected hyperlink, and wherein said sports page further contains a search hyperlink which launches said search module.
   A query is received from a user, via the GUI, regarding sports related media. A search is performed on the database by way of the search module, thereby obtaining query results, and the query results are output to the user via the GUI.

In a further aspect, a method is provided for serving media based on user ratings. The method comprises (a) displaying a first sequence of suggested media items to an online user, wherein each media item has a rating feature associated therewith through which the user may rate the media item; (b) receiving ratings from the user on at least some of the media items in the first sequence; and (c) displaying a second sequence of suggested media items to an online user, wherein each media item in the second sequence is selected based at least partially on the ratings received by the user from the first sequence.

In still another aspect, a tangible, non-transient medium is provided having suitable programming instructions recorded therein which, when executed by at least one computer processor, cause the computer to perform any or all of the steps of the methods described herein.

### BRIEF DESCRIPTION OF THE DRAWINGS

For a more complete understanding of the present invention and the advantages thereof, reference is now made to the following description taken in conjunction with the accompanying drawings in which like reference numerals indicate like features.

FIGS. 1-7 are screenshots from a first embodiment of a web-based application in accordance with the teachings herein.

### DETAILED DESCRIPTION OF THE INVENTION

While the foregoing digital media systems may have some desirable features and attributes, further needs still remain in the art which are not adequately addressed by these systems. For example, these systems do not provide a customizable, web-based application in which a user can conduct Boolean searches to identify media of interest to the user, and in which the search may be made in context to maximize relevant search results. These and other needs may be met by the systems and methodologies described herein.

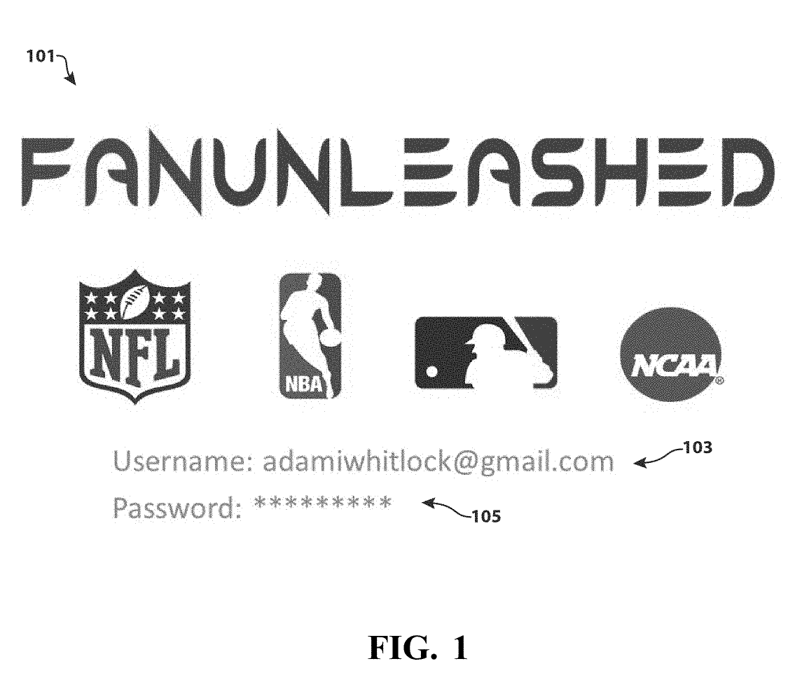

FIGS. 1-7 depict a series of web pages from a first particular, non-limiting embodiment of a web-based application in accordance with the teachings herein. It will be appreciated that, for simplicity of explanation and illustration, the web pages in this embodiment are basic, and are merely intended to depict the general process flow of the application. Hence, the actual web pages appearing in a fully functional embodiment of the application may have different and/or additional elements and graphical content. By way of example and not limitation, such web pages may be equipped with various menus, scrollbars, navigational links, input/output fields, selectable objects, graphics, and other such accoutrements as are known in the art of web-based applications.

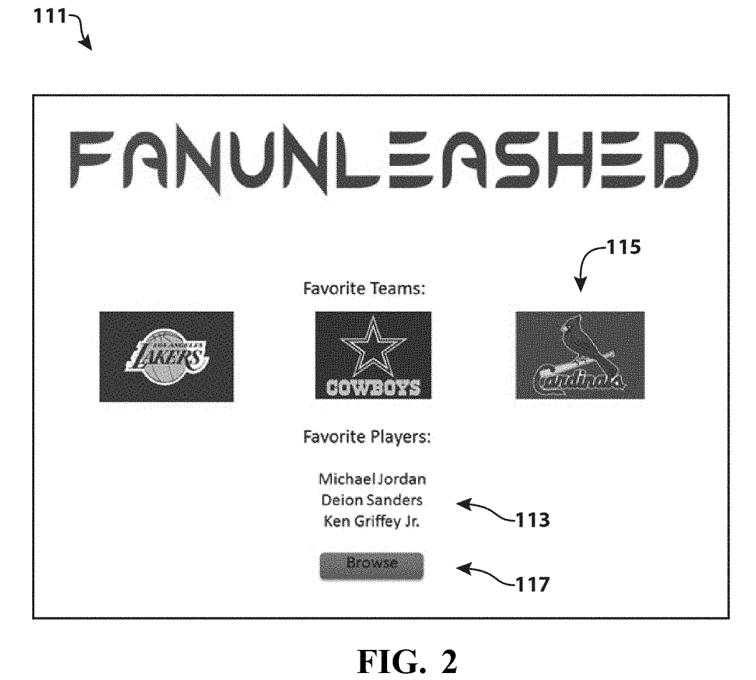

With reference to FIG. 1, upon launch, and possibly after the rendering of one or more splash screens, the application presents a login page 101 on which the user is queried for a user name 103 and password 105. Upon entry of this information, the application verifies the login information and, if the entered information matches the login information of record for a registered user, presents the main browsing page 111 (see FIG. 2) of the application.

If the username and/or password entered does not match the information of record for a registered user, a suitable error message is generated, and the user is again prompted for a username and password. In some embodiments, an account associated with a user may become locked if some number of unsuccessful attempts beyond a certain threshold amount are made to access the account, thus requiring remedial action on the part of the user to unlock the account.

FIG. 2 depicts the main browsing page 111 for the web-based application. This page may be utilized by the user to discover sports related digital media that meets search criteria input by the user. Such digital media may include videos, pictures, and audio recordings of athletes, training sessions, sporting events, sporting venues, and the like.

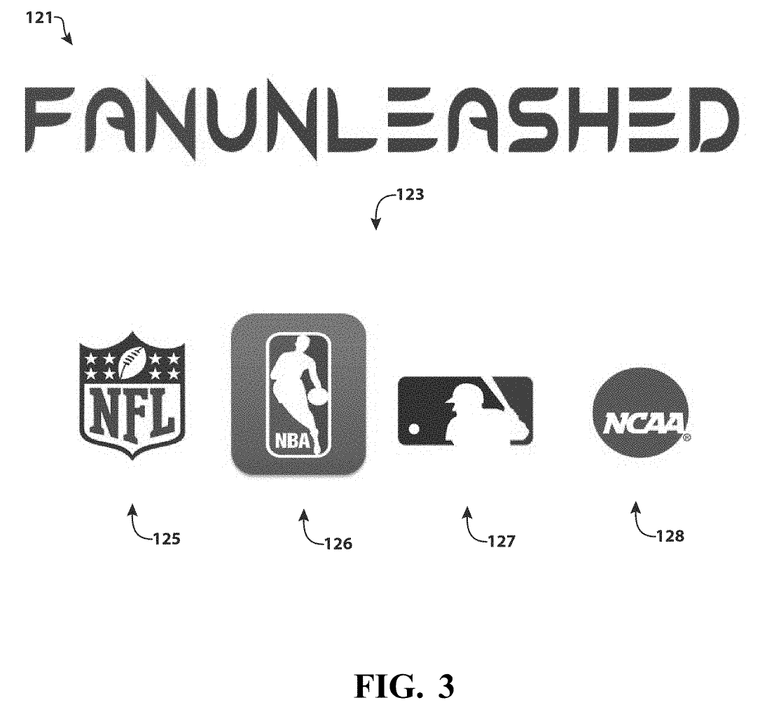

During initial setup of the web-based application, the user's sporting interests are ascertained through suitable application-generated queries. This may involve, for example, requesting that the user identify particular sports, teams and players that the user is interested in. After setup, the main browsing screen 111 reflects the user's choices or designations in textual 113 or graphical renditions 115. Thus, in the example depicted, the user has indicated an interest in the Dallas Cowboys football team, the Los Angeles Lakers basketball team, and the St. Louis Cardinals baseball team. The user has also indicated an interest in former Chicago Bulls basketball star Michael Jordan, former Dallas Cowboys defensive end Deion Sanders, and former Seattle Mariners outfielder Ken Griffey Jr. The user may add to, delete from, or edit these designations at any time through the use, for example, of a control panel or settings page or menu (not shown). The main browsing screen 111 is also equipped with a browse hyperlink 117 (which, in the particular embodiment depicted, is in the form of a tab), the selection of which launches the category browsing page 121 depicted in FIG. 3.

With reference to FIG. 3, the category browsing screen 121 allows the user to specify a sport of interest for a media search. In the particular embodiment depicted, this is accomplished by providing a plurality of hyperlinks in the form of icons 123 which are selectable by the user. While the embodiment depicted has icons 123 for the National Football League (NFL) 125, the National Basketball Association (NBA) 126, Major League Baseball 127, and the National Collegiate Athletic Association (NCAA) 128, it will be appreciated that similar hyperlinks may be presented for a variety of other leagues, associations or organizations. These hyperlinks may have various designs, color schemes, shapes, logos, text, or other attributes which may suggest the content and/or entity they are associated with.

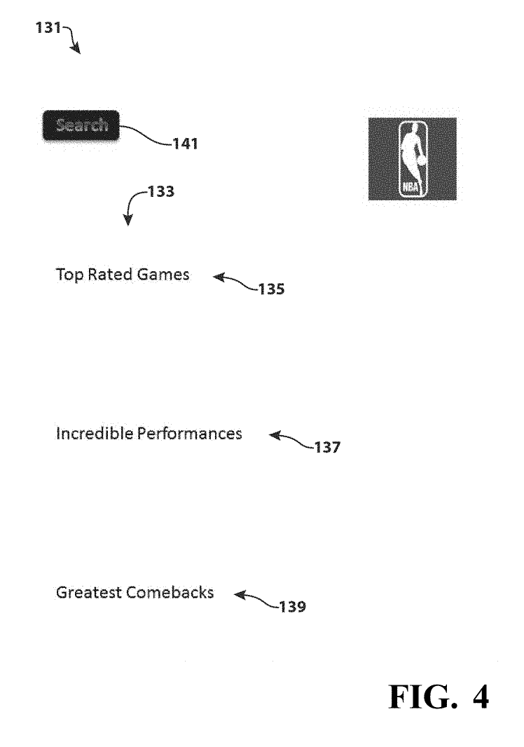

Selection of one of the presented hyperlinks 123 in FIG. 3 launches the search criteria page 131 depicted in FIG. 4. The search criteria page 131 has a listing of selectable hyperlinks 133 for common searches, such as top rated games 135, incredible performances 137 and greatest comebacks 139. In the particular embodiment depicted, the hyperlinks 133 are textual, although one skilled in the art will appreciate that other types of hyperlinks, including those that are icon or image based, may be utilized instead of, or in addition to, textual hyperlinks.

In a preferred embodiment, selection of any of the hyperlinks 133 will launch a search on a digital media database using the selected terms, while also constraining the returned results to the sport indicated by the user as being of interest. Thus, for example, in the particular embodiment depicted, the user has selected NBA basketball as the sport of interest. Hence, selection of, for example, the “Top Rated Games” hyperlink 135 will return a listing of top rated NBA games. This listing may be prioritized to reflect the user's indicated interests. Thus, for example, since the user has indicated an interest in the Los Angeles Lakers, the results listing may place Lakers games at the top of the listing. Since the user has also indicated an interest in Michael Jordan, Lakers games involving Michael Jordan may be further prioritized. Of course, the results may be prioritized in various other ways including, for example, by date, by popularity (as reflected, for example, by user voting), or by various other metrics. The application may also be equipped with suitable means to allow the user to customize or add to the list of common search terms.

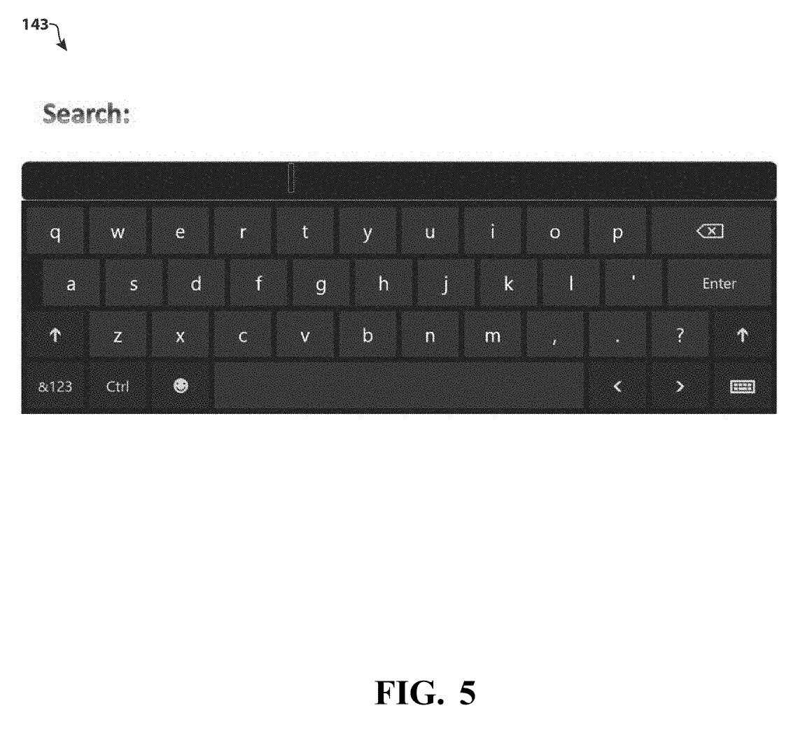

The search criteria page 131 is also equipped with a search button 141. Selection of the search button 141 launches the search box 143 depicted in FIG. 5, in which the user may enter various Boolean search terms for retrieval of media from the media database.

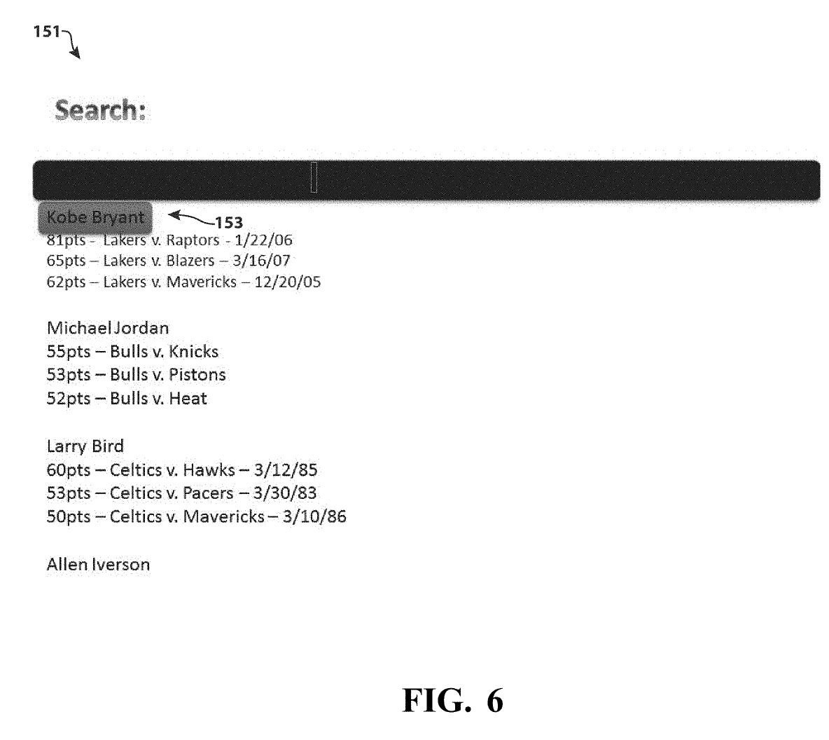

FIG. 6 shows the search results page 151, which is generated after selection of the hyperlinks on the search criteria page 131 and/or the entry of search terms in search box 143. In this particular case, the results are for selection of the “Incredible Performances” hyperlink 137 of FIG. 4, after selection of the NBA hyperlink 126 in FIG. 3. The results in the results listing have been prioritized to reflect the user's indicated interest in the Los Angeles Lakers and Michael Jordan, and are broken down by player. Each result indicates the opponents and the points scored by the player.

Of course, it will be appreciated that various other ways of presenting the search results to the user may be utilized. For example, in some embodiments, the search results page 151 may be equipped with selectable category tabs, the selection of which allows the user to sort the results by, for example, date, file size, alphabetically, or in other ways.

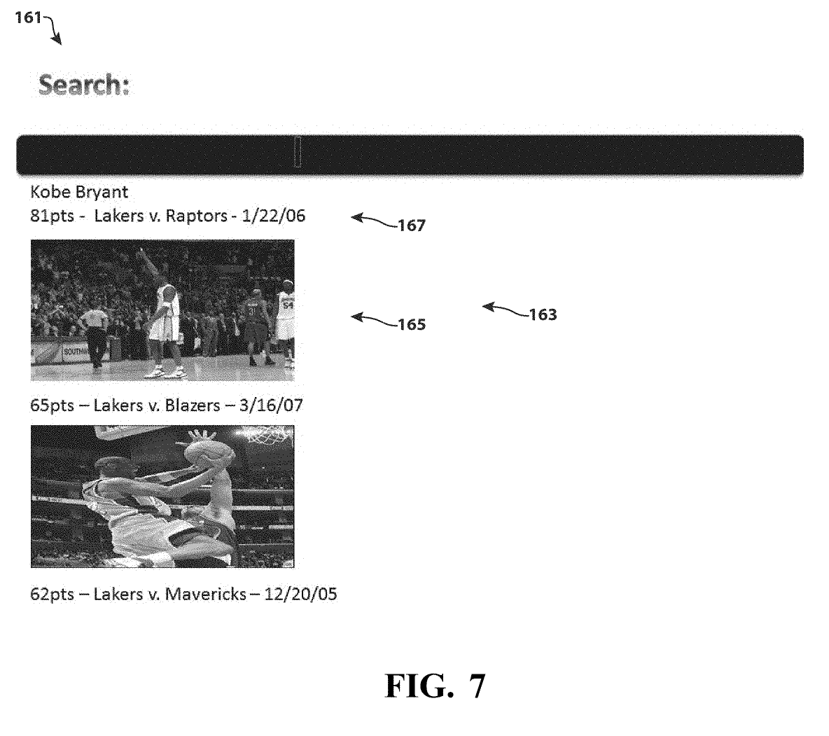

Selection of a player 153 in the search results page 151 of FIG. 6 launches the detailed search result page 161 shown in FIG. 7. As seen therein, each result 163 has a thumbnail 165 of the game or event in question, along with a corresponding textual description 167. Selection of the thumbnail 165 by the user preferably launches a suitable media player. For example, if the media is a video, selection of the thumbnail launches a video player. Similarly, if the media is a set of pictures or photos, selection of the thumbnail may launch a slideshow or other photo viewing software.

The web-based application disclosed herein may have various modes of operation. For example, in some embodiments, the application may have a “Surprise Me!” mode (which may be accessible, for example, through an icon or hyperlink placed on the search criteria page 131 of FIG. 4 or on another page or screen) which the user may select when the user does not wish to enter any search terms. Upon selection of this mode, the application will display one or more sporting events selected at random from a set of sporting events which meet preferences selected by the user. These preferences may be set by the user in an associated “Surprise Me!” menu which may be accessible during set-up or by way of a suitable control panel. These preferences may, for example, identify teams or players a user enjoys watching, or eras a user enjoys watching sporting events from. These preferences may further identify the types of games a user enjoys watching (these may include, for example, back and forth games, physical games, or games with close finishes or significant implications).

The pages associated with the “Surprise Me!” mode may have various navigational, textual or graphical features to enhance the user's experience. For example, these pages may provide a title and brief summary for each sporting event depicted or played on the page. A skip function may be provided so that the user may readily skip (in either direction) through a long sequence of suggested random sporting events or games. Various rating features (e.g., thumbs up, thumbs down) may be provided to allow a user to rate a suggested game so that the system may better learn the user's preferences (or those of a community of users).

It will be appreciated that the foregoing rating feature, which allows a system to learn a user's preferences by having the user rate media which the system presents to them, may have various applications beyond the particular application disclosed herein. Thus, for example, this feature may be utilized in an online entertainment system such as that provided by Netflix, where it may provide a streamlined process by which the system is able to pick shows for the user based on a preferences set established by such a rating system.

The web-based application disclosed herein may be implemented in various formats. For example, it may be implemented in a client-server format, in which a software client resident on a device associated with the user communicates with a server application to search for and produce media of interest to a user. The server in such a configuration may be in communication with one or more media databases which contains media content from a variety of sporting events in a variety of sports.

The web-based application disclosed herein may be utilized with a variety of client devices. These include, without limitation, various mobile technology platforms, such as smart phones, cellular phones, or personal digital assistants (PDAs), laptops, desktops, television monitors, and the like.

The web-based application and the associated service disclosed herein may be associated with, or used in conjunction with, one or more fan forums, web sites or other such organizations that serve to create community engagement or a community of users from fans of a sport, team, organization or event. For example, the web-based application may link to an associated web site or forum on which fans of a team, organization or sport may discuss various topics of interest with each other. The web site or forum may have discussion groups geared towards specific teams, organizations or sports, and may further offer users the ability to write blog posts about past games. Popular bloggers may be offered positions as official writers for the website or forum.

It will also be appreciated that the various systems and methodologies disclosed herein may be implemented through the use of one or more software programs. These programs may exist, for example, as suitable programming instructions which are disposed in a tangible, non-transient, computer readable medium and which, when implemented by one or more computer processors, cause or enable the systems and methodologies disclosed herein to be performed, created or utilized.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A web-based system for retrieving media from selected sporting events, comprising:
a graphical user interface (GUI) which receives queries regarding sports related media from a user, and which outputs query results in response thereto;
a login module which, in response to user input, uniquely identifies a user;
a user interest module which identifies sporting interests of the user based on user input;
a graphics content module which displays graphics content on the GUI based on the sporting interests of the user;
a media database containing media content from a plurality of sporting events in a plurality of sports;
a search module which receives search parameters from a user, performs a search on the media database on the basis of the received search parameters, and outputs search results in the form of a listing of media which satisfies the received search parameters; and
a sports module which displays a plurality of hyperlinks, each relating to a particular sport, wherein selection of one of said plurality of hyperlinks launches a sports page related to the sport associated with the selected hyperlink, wherein said sports page contains a plurality of content categories for media in the media database related to the sport associated with the selected hyperlink, and wherein said sports page further contains a search hyperlink which launches said search module.

2. The system of claim 1, wherein the media in said media database is categorized by sport.

3. The system of claim 2, wherein selection of said search hyperlink adds a parameter, to the search parameters input by the user, which further restricts the search to the sport category associated with the sports page.

4. The system of claim 1, wherein each of said plurality of hyperlinks is an icon.

5. The system of claim 4, wherein said media content includes videos.

6. The system of claim 1, wherein results in the listing of media are selectable by the user.

7. The system of claim 6, wherein selection by a user of a result in the listing of media launches a media player which plays or displays the selected media.

8. The system of claim 1, wherein the media includes video or audio media, and wherein the media player plays the video or audio media.

9. A method for serving sports related media on demand, comprising:
providing a media database containing media content from a plurality of sporting events in a plurality of sports;
providing a web-based application which includes
(g) a graphical user interface (GUI),
(h) a login module which, in response to user input, uniquely identifies a user,
(i) a user interest module which identifies sporting interests of the user based on user input,
(j) a graphics content module which displays graphics content on the GUI based on the sporting interests of the user,
(k) a search module which receives search parameters, performs a search on the media database on the basis of the received search parameters, and outputs search results in the form of a listing of media which satisfies the search parameters, and
(l) a sports module which displays on the GUI a plurality of hyperlinks, each relating to a particular sport, wherein selection of one of said plurality of icons launches a sports page related to the sport associated with the selected hyperlink, wherein said sports page contains a plurality of content categories for media in the media database related to the sport associated with the selected hyperlink, and wherein said sports page further contains a search hyperlink which launches said search module;
receiving, via the GUI, a query from a user regarding sports related media;
performing a search on the database by way of the search module, thereby obtaining query results; and
outputting the query results via the GUI.

10. The method of claim 9, further comprising:
prompting a user for identification input via the GUI, wherein the identification input uniquely identifies the user.

11. The method of claim 10, wherein the identification input includes a user ID and password.

12. The method of claim 9, further comprising:
prompting a user via the GUI for sporting interests information, wherein the sporting interests information identifies teams and sports which are of interest to the user.

13. The method of claim 12, wherein the step of prompting a user via the GUI for sporting interests information is implemented by the sporting interests module, wherein the resulting sporting interests information is passed to the graphics content module, and wherein the graphics content module renders graphic content associated with the teams and sports identified by the user as being of interest.

14. The method of claim 9, further comprising:
displaying on the GUI a plurality of hyperlinks, each relating to a particular sport;
receiving a selection of one of said plurality of hyperlinks from a user; and
launching a sports page related to the sport associated with the selected icon, wherein said sports page contains a plurality of content categories for media in the media database related to the sport associated with the selected icon, and wherein said sports page further contains a search hyperlink which launches said search module.

15. A tangible, non-transient medium having suitable programming instructions recorded therein which, when executed by at least one computer processor, cause the computer to perform the method of claim 9.

16. A method for serving media based on user ratings, comprising:
displaying a first sequence of suggested media items to an online user, wherein each media item has a rating feature associated therewith through which the user may rate the media item;
receiving ratings from the user on at least some of the media items in the first sequence; and
displaying a second sequence of suggested media items to an online user, wherein each media item in the second sequence is selected based at least partially on the ratings received by the user from the first sequence.

17. The method of claim 16, wherein each media item is a video.

18. The method of claim 16, wherein the rating feature is a Boolean variable which indicates whether the user liked or disliked a media item.

19. The method of claim 16, wherein each media item has a set of tags associated therewith, and wherein the tangs are used in conjunction with the received ratings to generate the second sequence.
